(19) United States
(12) Patent Application Publication
(10) Pub. No.: US 2004/0020331 A1
(43) Pub. Date: Feb. 5, 2004

(54) Wrench having a telescopic handle

(76) Inventor: Jack Lee, Chia Yi Hsien (TW)

Correspondence Address: CHARLES E. BAXLEY, ESQUIRE, Hart, Baxley, Daniels & Holton, 5 Fl, 59 John St., New York, NY, 10038, US

(21) Appl. No.: 10/210,287

(22) Filed: Aug. 2, 2002

(51) Int. Cl. B25B 23/16

(52) U.S. Cl. 81/177.2

(57) ABSTRACT

A wrench includes an elongated shank, an elongated telescopic handle telescopically and slidably mounted on the shank and having an inner wall formed with a retaining guide track, and a retaining ball secured on a distal end of the elongated shank to move therewith and guided by the retaining guide track of the telescopic handle. Thus, when the shank is moved in the telescopic handle, the retaining ball is retained to move in the retaining guide track of the telescopic handle, so that the shank is moved in the telescopic handle in a linear and straight manner, and will not rotate relative to the telescopic handle during movement by limit and guidance of the retaining guide track of the telescopic handle.

### BACKGROUND OF THE INVENTION

1. Field of the Invention

The present invention relates to a wrench, and more particularly to a wrench having a telescopic handle, wherein the shank is moved in the telescopic handle in a linear and straight manner, and will not rotate relative to the telescopic handle during movement.

2. Description of the Related Art

A conventional wrench includes a wrench body, and a shank extending from the wrench body for rotating the wrench body to operate a workpiece such as a nut, a bolt or the like. In general, the wrench often needs to exert a torque of different strengths for operating workpieces of different sizes. For example, the wrench usually needs a larger torque for operating a heavier workpiece, and needs a smaller torque for operating a lighter or smaller workpiece. However, the length of the shank is fixed so that the shank can only provide a torque of a fixed strength on the wrench body for operating the workpiece, thereby decreasing and limiting the versatility of the wrench.

The closest prior art of which the applicant is aware is disclosed in his U.S. patent application Ser. No. 09/584,023, which has been allowed by the Examiner.

### SUMMARY OF THE INVENTION

The primary objective of the present invention is to provide a wrench having a telescopic handle for arbitrarily adjusting the length of the force arm of the wrench so that the wrench includes an adjustable and variable force arm so as to provide a torque of various strengths for operating workpieces which need torque of different strengths, thereby increasing the versatility of the wrench.

Another objective of the present invention is to provide a wrench, wherein the shank is moved in the telescopic handle in a linear and straight manner, and will not rotate relative to the telescopic handle during movement In accordance with the present invention, there is provided a wrench comprising:

an elongated shank;

an elongated telescopic handle telescopically and slidably mounted on the shank, the elongated telescopic handle having an inner wall formed with a retaining guide track; and

a retaining ball secured on a distal end of the elongated shank to move therewith, and guided by the retaining guide track of the telescopic handle;

wherein, when the shank is moved in the telescopic handle, the retaining ball is retained to move in the retaining guide track of the telescopic handle, so that the shank is moved in the telescopic handle in a linear and straight manner, and will not rotate relative to the telescopic handle during movement by limit and guidance of the retaining guide track of the telescopic handle.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a wrench having a telescopic handle in accordance with the present invention;

FIG. 2 is a front plan cross-sectional view of the wrench as shown in FIG. 1;

FIG. 3 is an enlarged view of the wrench as shown in FIG. 2;

FIG. 4 is an operational view of the wrench as shown in FIG. 2; and

FIG. 5 is an operational view of the wrench as shown in FIG. 2.

### DETAILED DESCRIPTION OF THE INVENTION

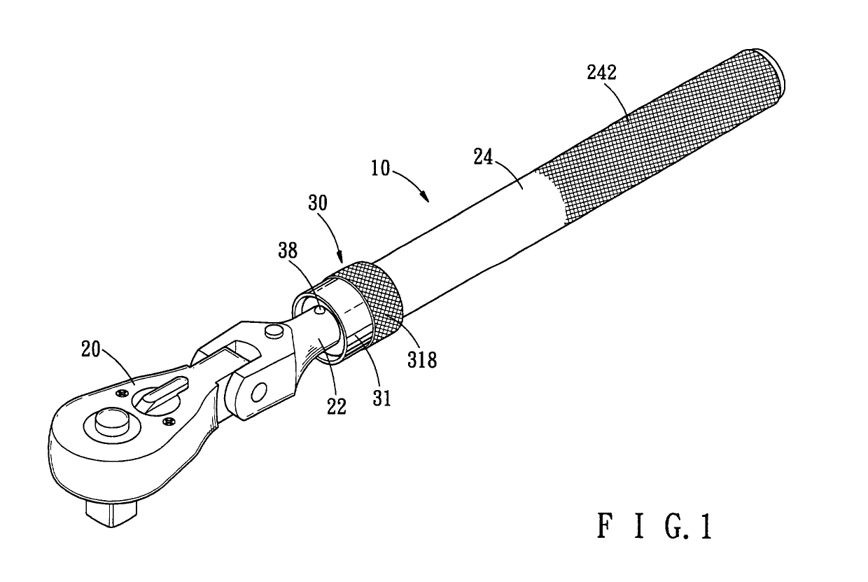

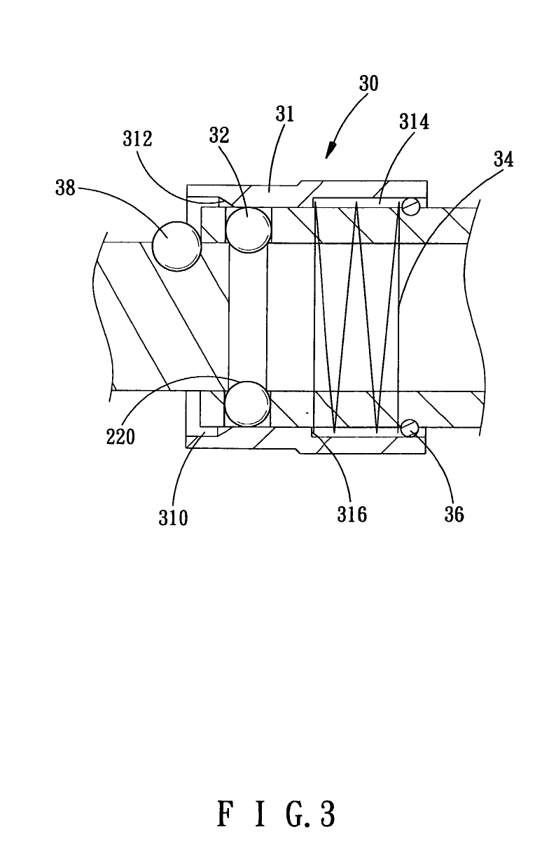

Referring to the drawings and initially to FIGS. 1-3, a wrench 10 in accordance with the present invention comprises a wrench body 20, an elongated shank 22 mounted on or extending from the wrench body 20 and having an outer periphery defining a plurality of annular retaining grooves 220, an elongated telescopic handle 24 telescopically and slidably mounted on the shank 22, and an adjusting device 30 mounted between the shank 22 and the telescopic handle 24 for adjustably securing the telescopic handle 24 on the shank 22.

The adjusting device 30 includes an adjusting ring 31 slidably mounted on a first end of the telescopic handle 24 and having a first end having an inner wall formed with a receiving recess 310, and a plurality of locking balls 32 each movably mounted in the first end of the telescopic handle 24 and each detachably secured in a respective one of the retaining grooves 220 of the shank 22. The receiving recess 310 of the adjusting ring 31 includes a tapered guide neck 312 for introducing each of the locking balls 32 into the receiving recess 310.

By such an arrangement, the adjusting ring 31 is slidable on the first end of the telescopic handle 24 between a first position where each of the locking balls 32 is pressed by an inner wall of the adjusting ring 31 to be received in a respective one of the retaining grooves 220 of the shank 22 for positioning the telescopic handle 24 on the shank 22, and a second position where each of the locking balls 32 is introduced into the receiving recess 310 of the adjusting ring 31 to detach from the respective one retaining groove 220, thereby in turn releasing and detaching the telescopic handle 24 from the shank 22 such that the telescopic handle 24 is slidable on the shank 22.

The adjusting ring 31 includes a second end defining a chamber 314 provided with an annular abutting flange 316. The adjusting device 30 further includes a plurality of abutting beads 36 each secured in an outer periphery of the first end of the telescopic handle 24 and each received in the chamber 314 of the adjusting ring 31, and a biasing member 34, such as a spring, mounted on the telescopic handle 24, received in the chamber 314 of the adjusting ring 31 and pressed between the abutting flange 316 and the abutting beads 36.

The adjusting device 30 further includes a limiting ball 38 secured in the shank 22 and abutting the first end of the telescopic handle 24 for limiting the first end of the telescopic handle 24.

Preferably, the adjusting ring 31 includes a knurl 318 formed on an outer periphery thereof, and the telescopic handle 24 includes a knurl 242 formed on an outer periphery thereof.

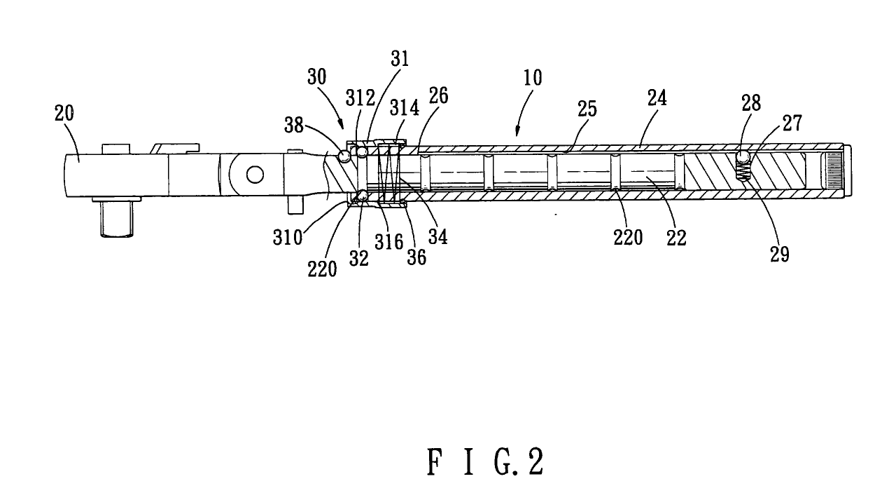

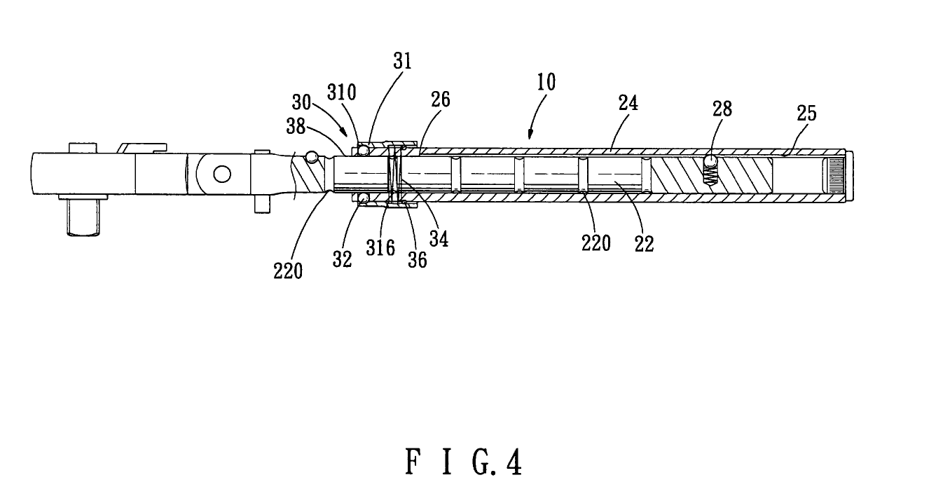

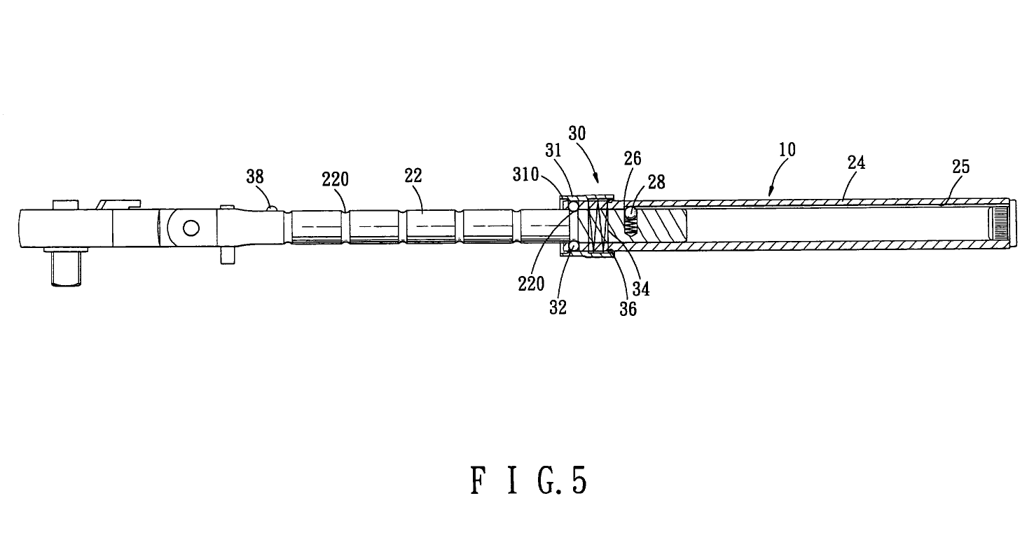

In operation, referring to FIGS. 4 and 5 with reference to FIGS. 1-3, the locking balls 32 are initially pressed by the inner wall of the adjusting ring 31 to be secured in a respective one of the retaining grooves 220 of the shank 22 so that the telescopic handle 24 is secured on the shank 22 as shown in FIG. 2.

The adjusting ring 31 is then moved rightward on the telescopic handle 24 from the position as shown in FIG. 2 to the position as shown in FIG. 4 so as to introduce the locking balls 32 into the receiving recess 310 of the adjusting ring 31 and to detach the locking balls 32 from the retaining groove 220 of the shank 22, thereby releasing the telescopic handle 24 from the shank 22 so that the telescopic handle 24 can be moved outward relative to the shank 22 from the position as shown in FIG. 4 to the position as shown in FIG. 5 so as to lengthen and extend the length of the force arm of the shank 22 so that the shank 22 together with the telescopic handle 24 can be adapted to provide a larger torque, thereby facilitating the wrench body 20 of the wrench 10 operating a workpiece (not shown) which needs a larger torque, thereby increasing the versatility of the wrench 10.

As shown in FIG. 5, when the balls 32 align with another retaining groove 220 of the shank 22, the adjusting ring 31 is then moved leftward on the telescopic handle 24 by means of the restoring force of the biasing member 34 to detach the locking balls 32 from the receiving recess 310, and to force the locking balls 32 into the retaining groove 220 by the inner wall of the adjusting ring 31, thereby positioning the telescopic handle 24 on the shank 22 again.

Preferably, the telescopic handle 24 has an inner wall formed with a retaining guide track 25 which is longitudinally extended in the inner wall of the telescopic handle 24. The retaining guide track 25 has one end provided with a stop flange 26 located adjacent to the adjusting ring 31. The shank 22 has a distal end formed with a receiving space 27 for receiving an elastic member 29 and a retaining ball 28 which is pressed by the elastic member 29 and is received in the retaining guide track 25 of the telescopic handle 24.

Thus, when the shank 22 is moved in the telescopic handle 24, the retaining ball 28 is moved with the shank 22, and is retained to move in the retaining guide track 25 of the telescopic handle 24, so that the shank 22 is moved in the telescopic handle 24 in a linear and straight manner, and will not rotate relative to the telescopic handle 24 during movement by limit and guidance of the retaining guide track 25 of the telescopic handle 24. In addition, when the shank 22 is moved in the telescopic handle 24 from the position as shown in FIG. 4 to the position as shown in FIG. 5, the retaining ball 28 is stopped by the stop flange 26 of the retaining guide track 25 of the telescopic handle 24, thereby preventing the telescopic handle 24 from detaching from the shank 22.

While the preferred embodiment(s) of the present invention has been shown and described, it will be apparent to those skilled in the art that various modifications may be made in the embodiment without departing from the spirit of the present invention. Such modifications are all within the scope of the present invention.

What is claimed is:

1. A wrench comprising:
an elongated shank;
an elongated telescopic handle telescopically and slidably mounted on said shank, said elongated telescopic handle having an inner wall formed with a retaining guide track; and
a retaining ball secured on a distal end of said elongated shank to move therewith, and guided by said retaining guide track of said telescopic handle;
wherein, when said shank is moved in said telescopic handle, said retaining ball is retained to move in said retaining guide track of said telescopic handle, so that said shank is moved in said telescopic handle in a linear and straight manner, and will not rotate relative to said telescopic handle during movement by limit and guidance of said retaining guide track of said telescopic handle.

2. The wrench in accordance with claim 1, further comprising an adjusting device mounted between said shank and said telescopic handle for adjustably securing said telescopic handle on said shank.

3. The wrench in accordance with claim 2, wherein said shank has an outer periphery defining a plurality of annular retaining grooves, and said adjusting device includes an adjusting ring slidably mounted on a first end of said telescopic handle and having a first end having an inner wall formed with a receiving recess, and a plurality of locking balls each movably mounted in said first end of said telescopic handle and each detachably secured in a respective one of said retaining grooves of said shank, wherein, said adjusting ring is slidable on said first end of said telescopic handle between a first position where each of said locking balls is pressed by an inner wall of said adjusting ring to be received in a respective one of said retaining grooves of said shank for positioning said telescopic handle on said shank, and a second position where each of said locking balls is introduced into said receiving recess of said adjusting ring to detach from said respective one retaining groove, thereby releasing and detaching said telescopic handle from said shank, such that said telescopic handle is slidable on said shank.

4. The wrench in accordance with claim 3, wherein said receiving recess of said adjusting ring is provided with a tapered guide neck for introducing each of said locking balls into said receiving recess.

5. The wrench in accordance with claim 3, wherein said adjusting ring has a second end formed with a chamber provided with an annular abutting flange, and said adjusting device further includes a plurality of abutting beads each secured in an outer periphery of said first end of said telescopic handle and each received in said chamber of said adjusting ring, and a biasing member mounted on said telescopic handle, received in said chamber of said adjusting ring and pressed between said abutting flange and said abutting beads.

6. The wrench in accordance with claim 3, wherein said adjusting device further includes a limiting ball secured in said shank and abutting said first end of said telescopic handle for limiting said first end of said telescopic handle.

7. The wrench in accordance with claim 1, wherein said retaining guide track is longitudinally extended in said inner wall of said telescopic handle.

8. The wrench in accordance with claim 1, wherein said retaining guide track has one end provided with a stop flange for stopping a further movement of said retaining ball.

9. The wrench in accordance with claim 1, wherein said distal end of said shank is formed with a receiving space for receiving said elastic member.

10. The wrench in accordance with claim 9, further comprising an elastic member received in said receiving space of said shank and urged on said retaining ball toward said retaining guide track of said telescopic handle.
